(19) United States
(12) Patent Application Publication
(10) Pub. No.: US 2026/0214043 A1
(43) Pub. Date: Jul. 23, 2026

(54) METHOD TO MAINTAIN LINK-STATE INFORMATION IN A MANNER THAT REDUCES THE PERFORMANCE IMPACT ON IGP (INTERIOR GATEWAY PROTOCOL) AND EGP (EXTERIOR GATEWAY PROTOCOL)

(71) Applicant: TELEFONAKTIEBOLAGET LM ERICSSON (PUBL), Stockholm (SE)

(72) Inventors: Kotesh Babu Chundu, Bangalore (IN); Gangadhara Reddy Chavva, Bangalore (IN)

(21) Appl. No.: 19/477,723

(22) PCT Filed: Apr. 22, 2023
(86) PCT No.: PCT/IN2023/050395

§ 371 Date: Oct. 22, 2025

(51) Int. Cl. H04L 45/03; H04L 45/02; H04L 45/122

(52) U.S. Cl. CPC H04L 45/03; H04L 45/04; H04L 45/122

(57) ABSTRACT

A method performed by a link-state information process executing on a network device is disclosed to maintain link-state information in a manner that reduces a performance impact on an interior gateway protocol (IGP) process and an exterior gateway protocol (EGP) process executing on the network device. The method includes obtaining a first protocol data unit of a first IGP from a first IGP process, updating a protocol-independent link-state database based on information included in the first protocol data unit, determining a first link-state information update to provide to the EGP process based on information included in the protocol-independent link-state database, encoding the first link-state information update in an EGP format to generate a first encoded link-state information update, and providing the first encoded link-state information update to the EGP process.

### TECHNICAL FIELD

Embodiments disclosed herein relate to the field of computer networks, and more specifically, to maintaining link-state information in a manner that reduces the performance impact on an interior gateway protocol (IGP) and an exterior gateway protocol (EGP), which improves the scalability of these protocols.

### BACKGROUND

An interior gateway protocol (IGP) is a type of routing protocol used for exchanging routing information between network devices (e.g., routers) within an autonomous system (AS). Open shortest path first (OSPF) and intermediate system to intermediate system (IS-IS) are examples of IGPs.

An exterior gateway protocol (EGP) is a routing protocol used to exchange routing information between autonomous systems. Border gateway protocol (BGP) is an example of an EGP.

Some applications, such as end-to-end traffic engineering (TE) applications (e.g., path computation element (PCE), as defined in request for comment (RFC) 4655) and network topology generation applications (e.g., application-layer traffic optimization (ALTO) servers), can benefit from having visibility outside of an IGP area (e.g., to make better decisions). In this regard, RFC 7752 describes a mechanism by which link-state information can be collected from networks and shared with external components using BGP. This is achieved using a new BGP link-state network layer reachability information (NLRI) encoding format. The mechanism is applicable to physical and virtual links. This mechanism may be referred to as BGP-LS (BGP link-state).

A network device may maintain one or more link-state databases for storing link-state information about nodes, links, prefixes, etc. in a given area. The link-state information stored in these link-state databases may include information regarding local/remote internet protocol (IP) addresses, local/remote interface identifiers, link metric and traffic engineering (TE) metrics, link bandwidth, reservable bandwidth, per class-of-service (CoS) class reservation state, preemption, and/or shared risk link groups (SRLGs). The network device's BGP process may obtain link-state information from these link-state databases and distribute it to a consumer, either directly or via a peer BGP speaker (typically a dedicated route reflector), using the encoding specified in RFC 7752.

Existing BGP-LS implementations leverage plugins/libraries running in the IGP process context to provide link-state information to the BGP process. The BGP process has to process this link-state information, encode link-state information updates in a BGP link-state NLRI encoding format, and send the encoded link-state information updates to remote BGP peers (e.g., in a BGP update message). The existing BGP-LS implementation puts an additional load on the IGP process and the BGP process, which affects the performance and scalability of IGP and BGP.

### SUMMARY

A method performed by a link-state information process executing on a network device is disclosed to maintain link-state information in a manner that reduces a performance impact on an interior gateway protocol (IGP) process and an exterior gateway protocol (EGP) process executing on the network device. The method includes obtaining a first protocol data unit of a first IGP from a first IGP process, updating a protocol-independent link-state database based on information included in the first protocol data unit, determining a first link-state information update to provide to the EGP process based on information included in the protocol-independent link-state database, encoding the first link-state information update in an EGP format to generate a first encoded link-state information update, and providing the first encoded link-state information update to the EGP process.

A non-transitory machine-readable medium is disclosed that comprises computer program code, which when executed by a network device, causes the network device to perform operations for maintaining link-state information in a manner that reduces a performance impact on an IGP process and an EGP process executing on the network device. The operations may be performed by a link-state information process that is separate from any IGP process and BGP process executing on the network device. The operations include obtaining a first protocol data unit of a first IGP from a first IGP process, updating a protocol-independent link-state database based on information included in the first protocol data unit, determining a first link-state information update to provide to the EGP process based on information included in the protocol-independent link-state database, encoding the first link-state information update in an EGP format to generate a first encoded link-state information update, and providing the first encoded link-state information update to the EGP process.

A network device is disclosed herein for maintaining link-state information in a manner that reduces a performance impact on an IGP process and an EGP process executing on the network device. The network device includes one or more processors and a non-transitory machine-readable storage medium having instructions stored therein, which when executed by the one or more processors, causes the network device to perform certain operations. The operations may be performed by a link-state information process that is separate from any IGP process and BGP process executing on the network device. The operations include obtaining a first protocol data unit of a first IGP from a first IGP process, updating a protocol-independent link-state database based on information included in the first protocol data unit, determining a first link-state information update to provide to the EGP process based on information included in the protocol-independent link-state database, encoding the first link-state information update in an EGP format to generate a first encoded link-state information update, and providing the first encoded link-state information update to the EGP process.

### BRIEF DESCRIPTION OF THE DRAWINGS

The invention may best be understood by referring to the following description and accompanying drawings that are used to illustrate embodiments of the invention. In the drawings:

FIG. 1 is a diagram showing a network device that implements a link-state information process, according to some embodiments.

FIG. 2 is a diagram showing an organization of a protocol-independent link-state database, according to some embodiments.

FIG. 3 is a diagram showing a BGP update message format, according to some embodiments.

FIG. 4 is a flow diagram of a method performed by a link-state information process executing on a network device for maintaining link-state information in a manner that reduces the performance impact on an IGP process and an EGP process executing on the same network device, according to some embodiments.

FIG. 5 is a flow diagram of another method performed by a link-state information process executing on a network device for maintaining link-state information in a manner that reduces the performance impact on an IGP process and an EGP process executing on the same network device, according to some embodiments.

FIG. 6A illustrates connectivity between network devices (NDs) within an exemplary network, as well as three exemplary implementations of the NDs, according to some embodiments.

FIG. 6B illustrates an exemplary way to implement a special-purpose network device according to some embodiments.

### DETAILED DESCRIPTION

The following description describes methods and apparatus for maintaining link-state information in a manner that reduces the performance impact on an interior gateway protocol (IGP) and an exterior gateway protocol (EGP). In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, existing BGP-LS implementations leverage plugins/libraries running in the IGP process context to provide link-state information to the BGP process. The BGP process has to process this link-state information, encode the link-state information in a BGP link-state network layer reachability (NLRI) encoding format, and send the encoded link-state information to remote BGP peers. The existing BGP-LS implementation puts an additional load on the IGP process and the BGP process, which affects the performance and scalability of IGP and BGP.

Existing BGP-LS implementations may have one or more of the following disadvantages.

(1) The IGP process (e.g., intermediate system to intermediate system (IS-IS) process and/or open shortest path first (OSPF) process) has to collect link-state information from protocol data units (PDUs) (e.g., link-state protocol data units (LSPs) or link-state advertisements (LSAs)), consolidate and store the relevant link-state information for BGP-LS in a link-state database, and provide this link-state information to the BGP process (e.g., as described in request for comment (RFC) 7752). The maintenance of link-state information for BGP-LS can negatively impact the core IGP performance, which can negatively impact IGP convergence. Timely IGP convergence is important to ensure proper routing in a network.

(2) BGP is already used to provide many services in addition to BGP-LS such as Layer 3 virtual private network (L3VPN), Ethernet virtual private network (EVPN), and BGP labeled unicast (BGP LU) to name a few examples. To support BGP-LS functionality, the BGP process has to process link-state information provided by IGPs, encode the link-state information updates in a BGP link-state NLRI encoding format (e.g., as described in RFC 7752), and generate BGP update messages, including the encoded link-state information updates, to send to remote BGP peers enabled for the link-state address family. This puts an additional load on the BGP process, which can negatively impact the performance and scalability of BGP.

(3) If a new router application wishes to leverage the BGP-LS database for end-to-end topology information, serving the new router application from the IGP processes or BGP process may negatively impact the performance of IGP and BGP.

As described above, the existing BGP-LS implementation design puts an additional load on the IGP processes and BGP process, which can negatively impact the performance and/or scalability of IGPs and BGP. In some cases, the extra overhead involved to support BGP-LS functionality (e.g., maintenance of a link-state database for BGP-LS) may negatively impact IGP convergence and BGP convergence, which is important for making proper routing decisions in a network.

A BGP-LS implementation design that relies heavily on IGP processes and/or the BGP process is not scalable, especially as an increasing number of applications internal to the protocol stack require access to end-to-end topology information.

Embodiments are described herein that can maintain link-state information in a routing protocol stack while reducing the impact on IGP and BGP. Embodiments achieve this by providing a new process (referred to herein as a “link-state information process”) that runs separately/independently from the IGP and BGP processes. The link-state information process may process the IGP-specific PDUs (e.g., e.g., LSPs and/or LSAs) and maintain a protocol-independent link-state database based on the information included in the PDUs. The link-state information process may encode link-state information updates in a BGP link-state NLRI encoding format (e.g., as described in RFC 7752) and provide the encoded link-state information to the BGP process so that the BGP process can send a BGP update message, including the encoded link-state information, to remote BGP peers.

With embodiments, the IGP PDU (e.g., LSP/LSA) processing, aggregation, and book-keeping tasks can be removed from the IGP processes (e.g., IS-IS/OSPF processes) and be handled by the new link-state information process. The new link-state information process may process the IGP-specific PDUs, update a protocol-independent link-state database based on the link-state information included in the PDUs, and encode link-state information updates in a BGP link-state NLRI encoding format. The link-state information process may provide the encoded link-state information updates to the BGP process. The BGP process may send BGP update messages, including the encoded link-state information updates (in BGP link-state NLRI encoding format), to remote BGP peers.

With embodiments, the IGP processes can implement a simple interface that provides the IGP-specific PDUs it receives to the link-state information process without having to perform any extra overhead activities specific to BGP-LS such as database maintenance, aggregation, and bookkeeping, which reduced the load on the IGP processes. Similarly, the BGP process (e.g., which, as mentioned above, may already be providing many other services such as L3VPN, EVPN, and BGP-LU) does not have to perform any extra overhead activities specific to BGP-LS such as BGP link-state NLRI encoding/decoding and bookkeeping. With embodiments, the new link-state information process may perform the BGP link-state NLRI encoding and decoding, which reduces the load on the BGP process.

With embodiments, since IGP PDU processing and link-state database maintenance is mostly handled by the new link-state information process, link-state information can be maintained in a protocol-independent manner so that if a routing application requires network topology information, it can be made available through a simple interface.

With embodiments, the BGP process can be a lightweight process that provides BGP update message transport. In some embodiments, a similar technique can be used to offload other services provided by BGP (e.g., L3VPN, EVPN, and/or BGP monitoring/security) to make the core BGP lean/lightweight.

With embodiments, if a routing application wishes to develop a new routing algorithm for SPF (shortest path first), the link-state information process may handle requests from the routing application and provide custom network topology information.

Embodiments may work in a protocol-independent manner by providing a subprocess referred to herein as a “protocol adaptation layer” process, which can process IGP-specific PDUs such as LSPs/LSAs and maintain a protocol-independent link-state database based on link-state information received via different IGPs. Embodiments can be extended to support other IGPs by adding protocol-specific hooks in the protocol adaption layer process.

Since the new link-state information process has complete network topology information, computation-heavy processing previously performed by the IGP processes can be delegated to this new process.

An advantage of embodiments disclosed herein is that by delegating link-state database maintenance tasks to a new/independent process, they reduce the load on the IGP and BGP processes, which can improve the performance and scalability of IGP and BGP.

Since embodiments work in a protocol-independent manner, common code can be reused via this new link-state information process, which helps keep the core IGP and BGP processes lightweight.

Embodiments can provide topology information for multiple IGP areas in a protocol-independent manner. Embodiments, can provide this topology information to applications via a simple interface to the link-state information process or via simple plugins as part of the link-state information process.

Embodiments delegate link-state database maintenance tasks to the new link-state information process, which helps reduce the load on IGP and BGP processes.

Embodiments allow IGP and/or BGP processes to delegate some of the protocol processing which requires end-to-end topology information to the new link-state information process, thereby improving the performance and scalability of IGP and/or BGP.

Since complete end-to-end topology information is separately maintained by the link-state information process, users can see the topology in a nice topology graph through a north bound interface and also through a client interface.

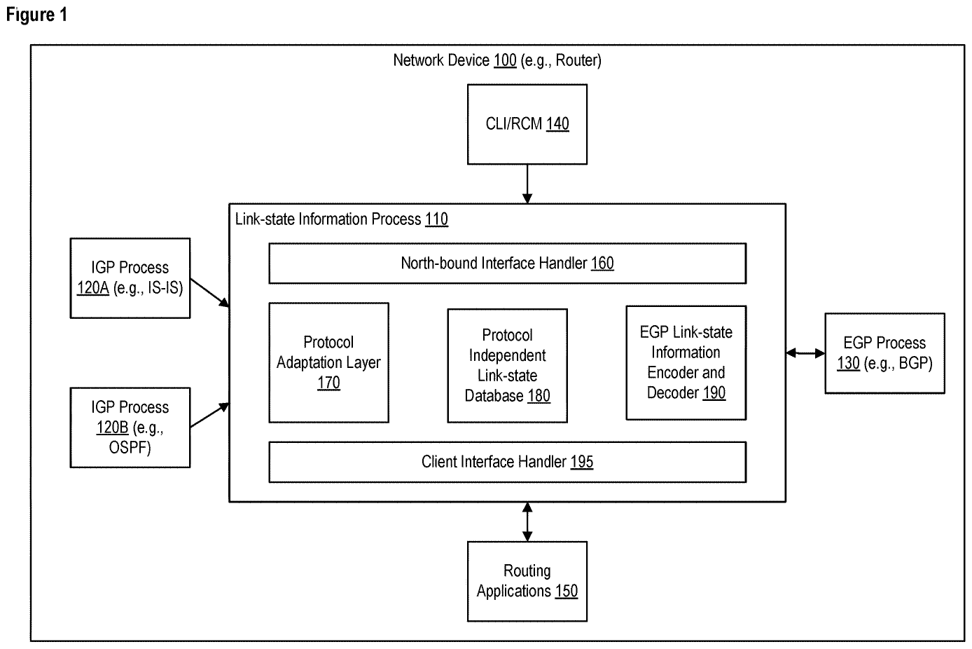

FIG. 1 is a diagram showing a network device that implements a link-state information process, according to some embodiments.

As shown in the diagram, the network device 100 executes IGP process 120A, IGP process 120B, a link-state information process 110, and an EGP process 130. In an embodiment, the network device 100 is a router.

Each of the IGP processes 120 may implement different IGPs. For example, IGP process 120A may implement IS-IS and IGP process 120B may implement OSPF. Although two IGP processes 120 are shown in the diagram, in other embodiments, the network device 100 may execute a different number of IGP processes (e.g., a single IGP process or more than two IGP processes). An IGP process 120 may obtain protocol-specific protocol data units (PDUs) received by the network device 100 and provide these PDUs to the link-state information process 110. A PDU is a single unit of information transmitted among peer entities of a computer network. The PDU for IS-IS may be a link state packet (LSP). The PDU for OSPF may be a link state advertisement (LSA). For example, IGP process 120A (e.g., which implements IS-IS) may obtain LSPs received by the network device 100 and provide these LSPs to the link-state information process 110. Also, IGP process 120B (e.g., which implements OSPF) may obtain LSAs received by the network device 100 and provide these LSAs to the link-state information process 110. Notably, the IGP processes 120 may provide PDUs to the link-state information process 110 as-is without performing any special processing (e.g., without reformatting the PDUs to a common format). That is, each IGP process 120 may merely forward PDUs it obtained to the link-state information process 110.

As shown in the diagram, the link-state information process 110 includes a protocol adaptation layer 170, a protocol-independent link-state database 180, and an EGP link-state information encoder and decoder 190.

The link-state information process 110 may obtain PDUs from the IGP processes 120. For example, the link-state information process 110 may obtain LSPs from IGP process 120A and obtain LSAs from IGP process 120B. The link-state information process 110 may provide the obtained PDUs to the protocol adaptation layer 170. The protocol adaptation layer 170 may be able to process different types of PDUs. For example, the protocol adaptation layer 170 may be able to process LSPs and LSAs. However, it will be appreciated that the protocol adaptation layer 170 may be able to process other types of PDUs.

The protocol adaptation layer 170 may parse PDUs in accordance with the appropriate protocol. The protocol adaptation layer 170 may extract link-state information included in the PDUs and merge/consolidate information related to the same link-state object. The protocol adaptation layer 170 may maintain bookkeeping information for PDUs it obtains to deduce the change set for a given PDU. This may involve determining whether link-state objects should be deleted, updated, and/or created. The protocol adaptation layer 170 may update the protocol-independent link-state database 180 based on the link-state information extracted from the PDUs.

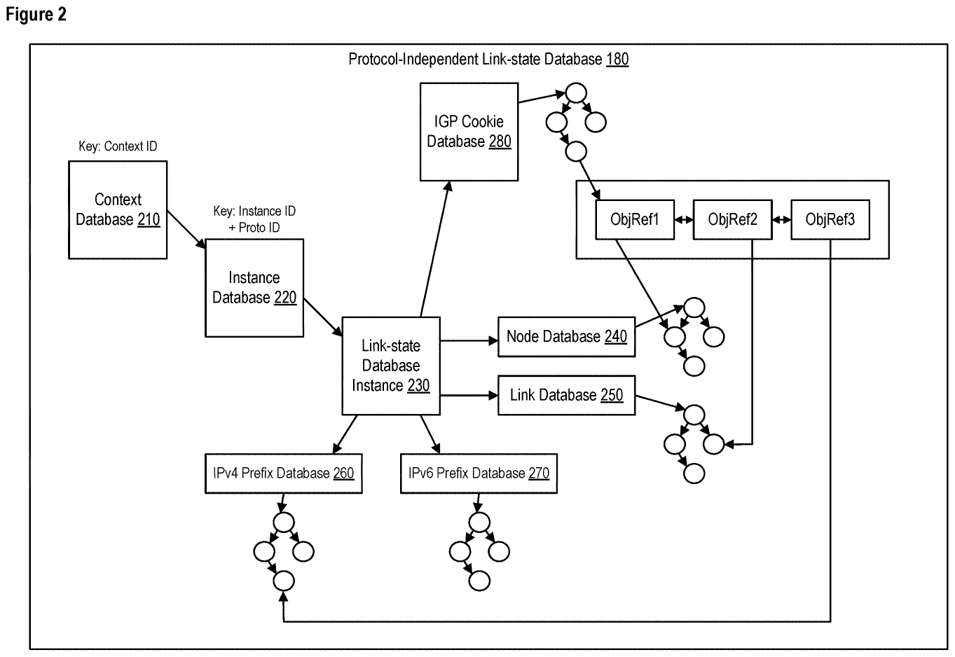

The protocol-independent link-state database 180 may be a database that stores link-state information in a protocol-independent manner (e.g., in a format that is different from the format used by IGPs to store link-state information). The link-state information stored in the protocol-independent link-state database 180 may include information regarding link-state objects such as nodes, links, and prefixes. An example organization of the protocol-independent link-state database 180 is shown in FIG. 2 and described further herein below.

The EGP link-state information encoder and decoder 190 may determine when there is a link-state information update to provide to the EGP process 130 (based on information included in the protocol-independent link-state database 180) and encode the link-state information update in an EGP format. The EGP link-state information encoder and decoder 190 may then provide the encoded link-state information update to the link-state information process 110, which may provide the encoded link-state information update to the EGP process 130. In an embodiment, the EGP process 130 is a BGP process that implements BGP and the EGP format is a BGP-LS NLRI encoding format.

The EGP process 130 may obtain an encoded link-state information update from the link-state information process 110, generate an EGP update message (e.g., BGP update message) that includes the encoded link-state information update, and cause the network device 100 to send the EGP update message to one or more EGP peers. Notably, since the EGP link-state information encoder and decoder 190 encodes the link-state information update in an EGP format, the EGP process 130 does not need perform such encoding, but can merely function as a forwarder that causes the encoded link-state information update it received from the link-state information process 110 to be sent to EGP peers (as part of an EGP update message).

The EGP process 130 may obtain a remote link-state information update that the network device 100 received from a remote EGP peer (e.g., in EGP update message). The EGP process 130 may provide the remote link-state information update it obtained to the link-state information process 110. The link-state information process 110 may provide the remote link-state information update to the EGP link-state information encoder and decoder 190. The EGP link-state information encoder and decoder 190 may decode the remote link-state information update and update the protocol-independent link-state database 180 based on the information included in the link-state information update. Notably, the EGP process 130 may provide the remote link-state information update it obtained to the EGP link-state information encoder and decoder 190 as-is without performing any special processing.

In this manner, the link-state information process 110 may handle the encoding of locally-generated link-state information updates in an EGP format, as well as decoding remotely-generated link-state information updates and updating the protocol-independent link-state database 180 based on information included in the decoded link-state information updates. By having a separate/independent link-state information process 110, the EGP process 130 itself is freed from having to perform special processing with regard to link-state information that is to be shared via the EGP.

Embodiments provide an efficient design for maintaining and generating link-state information of a routing domain while minimally impacting the performance/scalability/convergence of IGPs (e.g., IS-IS and OSPF) and BGP.

In an embodiment, new routing application plugins can be added as part of the new link-state information process 110 to provide topology-specific information. For example, if the underlying IGP domain is configured with segment routing, a user can request that the link-state information process 110 check if a given SID INDEX is already used by any nodes in the underlying IGP domain, and if so, the user can proactively rectify the configuration mistakes.

Having more information related to nodes/links/prefixes can provide more data on the resource usage and may suggest underutilized paths and/or overutilized paths between two end-points. In an embodiment, artificial intelligence or machine learning models can be used to suggest better traffic engineering paths for a set of end points for traffic forwarding.

Since complete network topology information is available, traffic engineering computation, which typically happens on software defined networking (SDN) controllers can be performed on headend nodes that implement the techniques described herein, where network topology information is maintained separately from IGP/BGP. This type of solution can help small network operators that may not have a SDN controller or other type of network management system (NMS).

In an embodiment, as shown in the diagram, the link-state information process 110 further includes a north-bound interface handler 160 and a client interface handler 195. The north-bound interface handler 160 may implement an interface that provides link-state information to users/customers and/or allows users/customers to configure the link-state information process 110. For example, a command line interface (CLI) or routing configuration manager (RCM) 140 may request and obtain link-state information from the link-state information process 110 via the north-bound interface handler.

The client interface handler 195 may implement an interface that provides link-state information to routing applications 150. For example, one or more routing applications 150 (e.g., a path computation element (PCE) application) executing on the network device 100 may request and obtain link-state information from the link-state information process 110 via the client interface handler 195. In an embodiment, the client interface handler 195 may provide link-state information in a format requested by the routing applications 150. For example, the client interface handler 195 may provide link-state information as a directed graph, in extensible Markup Language (XML) format, in JavaScript Object Notation (JSON) format, and/or in TXT (text) format.

By maintaining the protocol-independent link-state database 180 independently from IGP/BGP processes, innovative routing applications, which need network topology information, can easily request the such information from the protocol-independent link-state database 180 via the link-state information process 110. Also, by maintaining the protocol-independent link-state database 180, the link-state information process 110 may provide network topology information in a client requested format such as directed graph, XML, JSON, and/or TXT formats. With embodiments, if a routing application needs constrained SPFs (shortest path first) based on user-specific metrics (e.g., delay, bandwidth, etc.), this can be requested from the link-state information process 110 using a standard interface. Conventional constrained SPF (CSPF) implementations may not have all the required information and is tightly coupled with resource reservation protocol (RSVP). By maintaining a link-state database in a protocol-independent manner, embodiments help to provide a unified interface to offload customized SPF computations.

FIG. 2 is a diagram showing an organization of a protocol-independent link-state database, according to some embodiments.

The protocol-independent link-state database 180 may store link-state information in a protocol-independent manner. The protocol-independent link-state database 180 may maintain link-state information for each virtual router, IGP, and routing instance combination. As shown in the diagram, the protocol-independent link-state database 180 includes a context database 210, an instance database 220, and a link-state database instance 230. The context database 210 may store information for each context. Each context may correspond to a virtual router. The primary key of the context database 210 may be the context identifier (ID) (e.g., that uniquely identifies the context or virtual router). The instance database 220 may store information for each IGP and routing instance combination. The primary key of the instance database 220 may be a combination of the protocol ID (e.g., that uniquely identifies an IGP) and the instance ID (e.g., that uniquely identifies a routing instance). The link-state database instance 230 may store link-state information for a given virtual router, IGP, and routing instance combination. In an embodiment, the link-state database instance 230 includes or references a node database 240, a link database 250, an IPv4 prefix database 260, an IPV6 prefix database 270, and an IGP cookie database 280. For purposes of illustration, a single link-state database instance 230 is shown in the diagram. It should be appreciated that there can be additional link-state database instances 230 (e.g., one per virtual router, IGP, and routing instance combination).

The node database 240 may store information regarding network nodes. The link database 250 may store information regarding network links. The IPv4 prefix database 260 may store information regarding IPv4 prefixes. The IPV6 prefix database 270 may store information regarding IPv6 prefixes. The IGP cookie database 280 may store information regarding the PDUs that have been received over time to be able to deduce topology/network information changes/updates.

The protocol-independent link-state database 180 may store information regarding the relationships between link-state objects. For example, as shown in the diagram, “ObjRef1” may refer to a node object, “ObjRef2” may refer to a link object, and “ObjRef3” may refer to an IPv4 prefix object, and the protocol-independent link-state database 180 may store information indicating the relationships between these objects. As an example, for a given node, the protocol-independent link-state database 180 may store information regarding the links that are connected to the node. As another example, for a given link, the protocol-independent link-state database 180 may store information regarding the nodes connected to the link.

While the diagram shows the data stored in the protocol-independent link-state database 180 being organized in a particular manner, those skilled in the art will appreciate that the data stored in the protocol-independent link-state database 180 can be organized differently than shown in the diagram. The diagram should thus be regarded as illustrative rather than limiting.

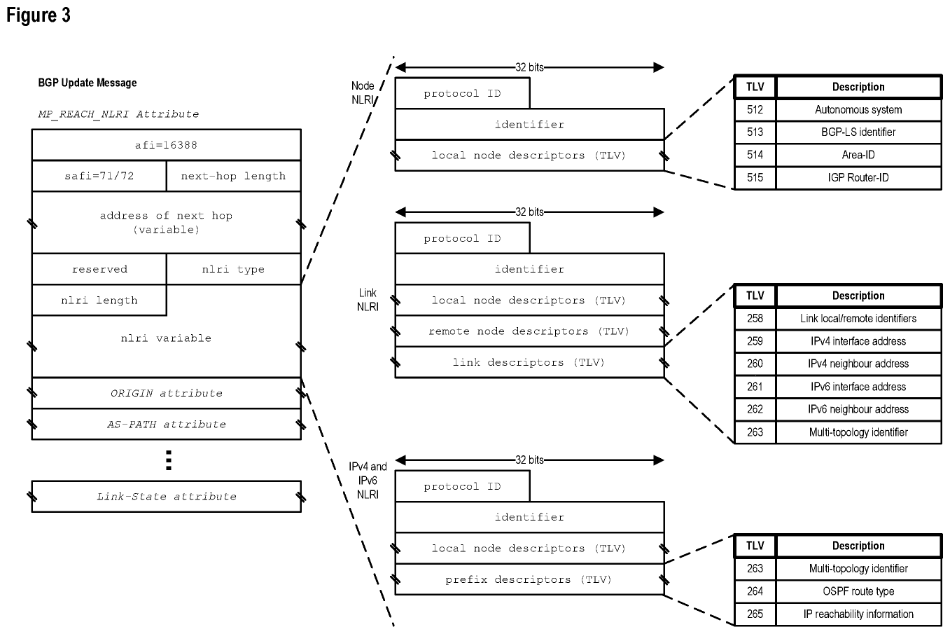

FIG. 3 is a diagram showing a BGP update message format, according to some embodiments.

As shown in the diagram, the BGP update message format includes a MP_REACH_NLRI (multi-protocol reachable NLRI) attribute that includes an address family identifier (AFI) field that is set to the value of “16388” (indicating BGP-LS) and a subsequent address family identifier (SAFI) field that is set to the value of “71” (indicating BGP-LS) or “72” (indicating BGP-LS-VPN, where VPN stands for virtual private network). The MP_REACH_NLRI Attribute further includes a NLRI variable field. The NLRI variable field may include a node NLRI, a link NLRI, and/or a IPv4/IPv6 NLRI. The node NLRI may include a protocol ID field, an identifier field, and a local node descriptors field (in type-length-value (TLV) format). Different TLV values can be used in the local node descriptors field to provide various information such as autonomous system, BGP-LS identifier, area ID, and/or IGP router ID. The link NLRI may include a protocol ID field, an identifier field, a local node descriptors field (in TLV format), a remote node descriptors field (in TLV format), and a link descriptors field (in TLV format). Different TLV values can be used in the link descriptors field to provide various information such as link local/remote identifiers, IPv4 interface address, IPv4 neighbour address, IPv6 interface address, IPv6 neighbour address, and/or multi-topology identifier. The IPv4/IPv6 prefix NLRI may include a protocol ID field, an identifier field, a local node descriptors field (in TLV format), and a prefix descriptors field (in TLV format). Different TLV values can be used in the prefix descriptors field to provide various information such as multi-topology identifier, OSPF route type, and/or IP reachability information. The MP_REACH_NLRI attribute may include additional fields such as a next-hop length field, an address of next hop field, a reserved field, a nlri type field, a nlri length field, an ORIGIN attribute field, an AS-PATH field, and a link-state attribute field.

The BGP update message format shown in the diagram may be interpreted as described in RFC 4760 and RFC 7752 and thus a detailed description for each field is not provided herein for the sake of brevity. While the base BGP-LS RFC (RFC 7532) describes link-state NLRIs for node/link/prefix objects, embodiments described herein can be extended to apply to BGP-LS extensions (e.g., to maintain information related to egress peer engineering, segment routing IPv6 (SRv6), etc.).

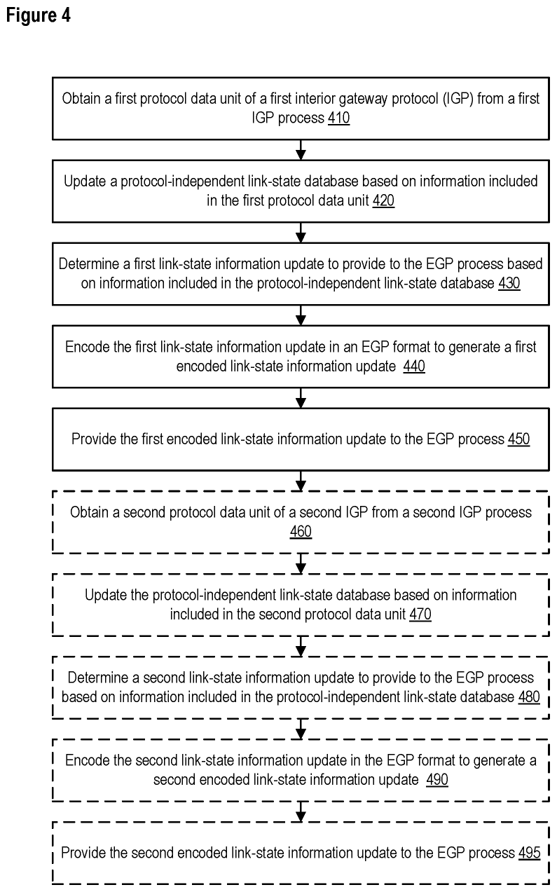

FIG. 4 is a flow diagram of a method performed by a link-state information process executing on a network device for maintaining link-state information in a manner that reduces the performance impact on an IGP process and an EGP process executing on the same network device, according to some embodiments.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

While the flow diagrams in the figures show a particular order of operations performed by certain embodiments, it should be understood that such order is provided by way of example and should not be regarded as limiting (e.g., alternative embodiments may perform the operations in a different order, combine certain operations, overlap certain operations, etc.).

At operation 410, the link-state information process obtains a first protocol data unit (PDU) of a first interior gateway protocol (IGP) from a first IPG process.

At operation 420, the link-state information process updates a protocol-independent link-state database based on information included in the first PDU. In an embodiment, the protocol-independent link-state database includes separate link-state database instances for different virtual router, IGP instance, and routing instance combinations.

At operation 430, the link-state information process determines a first link-state information update to provide to the EGP process based on information included in the protocol-independent link-state database. In an embodiment, the first link-state information update includes one or more of: information regarding a node, information regarding a link, and information regarding a prefix.

At operation 440, the link-state information process encodes the first link-state information update in an EGP format to generate a first encoded link-state information update.

At operation 450, the link-state information process provides the first encoded link-state information update to the EGP process. In an embodiment, the EGP process is configured to cause the first encoded link-state information update to be sent to a remote EGP peer.

In an embodiment, the link-state information process may also perform operations 460-495. At operation 460, the link-state information process obtains a second protocol data unit of a second IGP from a second IGP process. At operation 470, the link-state information process updates the protocol-independent link-state database based on information included in the second protocol data unit. At operation 480, the link-state information process determines a second link-state information update to provide to the EGP process based on information included in the protocol-independent link-state database. At operation 490, the link-state information process encodes the second link-state information update in the EGP format to generate a second encoded link-state information update. At operation 495, the link-state information process provides the second encoded link-state information update to the EGP process.

In an embodiment, the first IGP is OSPF, the first protocol data unit is a LSA, the second IGP is IS-IS, and the second protocol data unit is a LSP. In an embodiment, the EGP is BGP and the EGP format is a BGP link-state NLRI format.

In an embodiment, the link-state information process receives a request for link-state information from a routing application, generates a response corresponding to the request based on accessing information included in the protocol-independent link-state database, and provides the response to the routing application. In an embodiment, the response includes requested link-state information in a format requested by the routing application (e.g., JSON or XML format).

In an embodiment, the link-state information process includes a routing application plug-in that provides network topology information responsive to user requests, wherein the routing application plug-in generates the network topology information based on information included in the protocol-independent link-state database.

In an embodiment, the network device executes a machine learning model that generates routing paths between network nodes using information included in the protocol-independent link-state database.

In an embodiment, the network device executes a traffic engineering process that generates routing paths between network nodes using information included in the protocol-independent link-state database and configures network nodes to provide the routing paths.

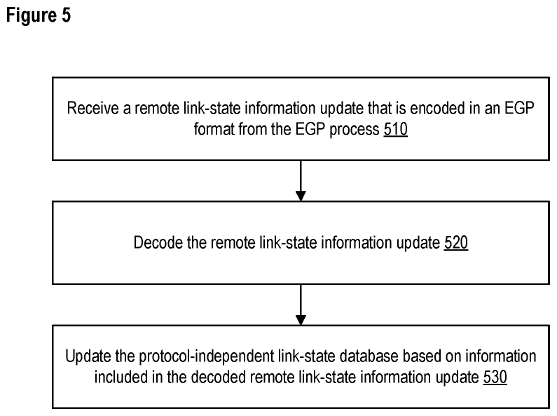

FIG. 5 is a flow diagram of another method performed by a link-state information process executing on a network device for maintaining link-state information in a manner that reduces the performance impact on an IGP process and an EGP process executing on the same network device, according to some embodiments.

At operation 510, the link-state information process obtains a remote link-state information update that is encoded in an EGP format from the EGP process. In an embodiment, the EGP process is a BGP process and the EGP format is a BGP link-state NLRI format.

At operation 520, the link-state information process decodes the remote link-state information update.

At operation 530, the link-state information process updates the protocol-independent link-state database based on information included in the decoded remote link-state information update.

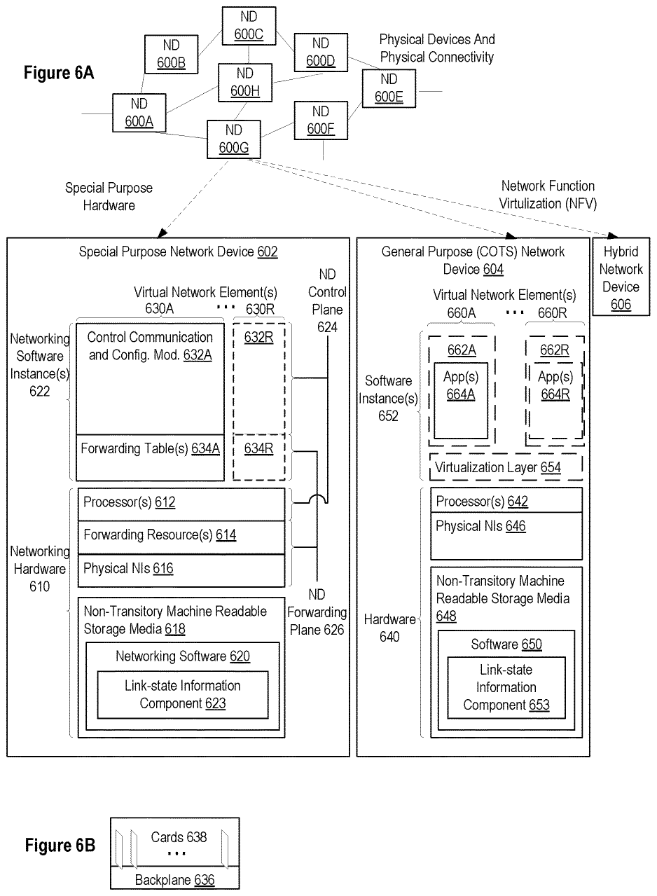

FIG. 6A illustrates connectivity between network devices (NDs) within an exemplary network, as well as three exemplary implementations of the NDs, according to some embodiments of the invention. FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated circuits (ASICs) and a special-purpose operating system (OS); and 2) a general purpose network device 604 that uses common off-the-shelf (COTS) processors and a standard OS.

The special-purpose network device 602 includes networking hardware 610 comprising a set of one or more processor(s) 612, forwarding resource(s) 614 (which typically include one or more ASICs and/or network processors), and physical network interfaces (NIs) 616 (through which network connections are made, such as those shown by the connectivity between NDs 600A-H), as well as non-transitory machine readable storage media 618 having stored therein networking software 620. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A).

The special-purpose network device 602 is often physically and/or logically considered to include: 1) a ND control plane 624 (sometimes referred to as a control plane) comprising the processor(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the processor(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

In an embodiment, software 620 includes code such as link-state information component 623, which when executed by networking hardware 610, causes the special-purpose network device 602 to perform operations of one or more embodiments disclosed herein (e.g., to maintain link-state information in a manner that reduces the performance impact on IGP and/or EGP).

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general purpose network device 604 includes hardware 640 comprising a set of one or more processor(s) 642 (which are often COTS processors) and physical NIs 646, as well as non-transitory machine readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor-the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the physical NI(s) 646, as well as optionally between the instances 662A-R; in addition, this virtual switch may enforce network isolation between the VNEs 660A-R that by policy are not permitted to communicate with each other (e.g., by honoring virtual local area networks (VLANs)).

In an embodiment, software 650 includes code such as link-state information component 653, which when executed by hardware 640, causes the general purpose network device 604 to perform operations of one or more embodiments disclosed herein (e.g., to maintain link-state information in a manner that reduces the performance impact on IGP and/or EGP).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

What is claimed is:

1. A method performed by a link-state information process executing on a network device to maintain link-state information in a manner that reduces a performance impact on an interior gateway protocol (IGP) process and an exterior gateway protocol (EGP) process executing on the network device, the method comprising:
obtaining a first protocol data unit of a first IGP from a first IGP process;
updating a protocol-independent link-state database based on information included in the first protocol data unit;
determining a first link-state information update to provide to the EGP process based on information included in the protocol-independent link-state database;
encoding the first link-state information update in an EGP format to generate a first encoded link-state information update; and
providing the first encoded link-state information update to the EGP process.

2. The method of claim 1, further comprising:
obtaining a second protocol data unit of a second IGP from a second IGP process;
updating the protocol-independent link-state database based on information included in the second protocol data unit;
determining a second link-state information update to provide to the EGP process based on information included in the protocol-independent link-state database;
encoding the second link-state information update in the EGP format to generate a second encoded link-state information update; and
providing the second encoded link-state information update to the EGP process.

3. The method of claim 2, wherein the first IGP is open shortest path first (OSPF), the first protocol data unit is a link state advertisement (LSA), the second IGP is intermediate system to intermediate system (IS-IS), and the second protocol data unit is a link state protocol data unit (LSP).

4. The method of claim 3, wherein the EGP is border gateway protocol (BGP) and the EGP format is a BGP link-state network layer reachability information (NLRI) format.

5. The method of claim 1, further comprising:
obtaining a remote link-state information update that is encoded in the EGP format from the EGP process;
decoding the remote link-state information update; and
updating the protocol-independent link-state database based on information included in the decoded remote link-state information update.

6. The method of claim 1, further comprising:
receiving a request for link-state information from a routing application;
generating a response corresponding to the request based on accessing information included in the protocol-independent link-state database; and
providing the response to the routing application.

7. The method of claim 6, wherein the response includes the requested link-state information in a format requested by the routing application.

8. The method of claim 1, wherein the first link-state information update includes one or more of: information regarding a node, information regarding a link, and information regarding a prefix.

9. The method of claim 1, wherein the protocol-independent link-state database includes separate link-state database instances for different virtual router, IGP instance, and routing instance combinations.

10. The method of claim 1, wherein the EGP process is configured to cause the first encoded link-state information update to be sent to a remote EGP peer.

11. The method of claim 1, wherein the link-state information process includes a routing application plug-in that provides network topology information responsive to user requests, wherein the routing application plug-in generates the network topology information based on information included in the protocol-independent link-state database.

12. The method of claim 1, wherein the network device executes a machine learning model that generates routing paths between network nodes using information included in the protocol-independent link-state database.

13. The method of claim 1, wherein the network device executes a traffic engineering process that generates routing paths between network nodes using information included in the protocol-independent link-state database and configures network nodes to provide the routing paths.

14. A non-transitory machine-readable medium comprising computer program code which when executed by a network device causes the network device to carry out the method steps of claim 1.

15. A network device comprising:
one or more processors; and
a non-transitory machine-readable storage medium having instructions stored therein, which when executed by the one or more processors, causes the network device to carry out the method steps claim 1.
